(19) United States
(12) Patent Application Publication
(10) Pub. No.: US 2005/0189344 A1
(43) Pub. Date: Sep. 1, 2005

(54) Boot/ski boot softener and warmer

(76) Inventor: Chris Bachman, Park City, UT (US)

Correspondence Address: MARCUS G THEODORE, PC, 466 SOUTH 500 EAST, SALT LAKE CITY, UT, 84102, US

(21) Appl. No.: 11/052,497

(22) Filed: Feb. 7, 2005

Related U.S. Application Data
(60) Provisional application No. 60/548,184, filed on Mar. 1, 2004.

(51) Int. Cl. H05B 3/34; H05B 6/64

(52) U.S. Cl. 219/528; 219/217; 219/553; 219/680

(57) ABSTRACT

An improved pair of reusable heatable inserts, with a heat-regulating sleeve, which may be used for selective boot softening and warming or heating of articles of clothing.

### RELATED APPLICATIONS

This application is a continuation-in-part application of the provisional patent application, Ser. No. 60/548,184 filed Mar. 1, 2004 entitled Boot/Ski Boot Softener and Warmer.

### BACKGROUND OF THE INVENTION

1. Field

This invention pertains to boot softeners and warmers. In particular it pertains to an improved boot warmer for boots such as ski boots, which benefit from being softened and warmed before usage to provide a comfortable fit.

2. State of the Art

A number of boot warmers are known, such as Yeager, U.S. Pat. No. 6,148,545 dated Nov. 21, 2000, which a reheatable warmer sized to fit within a boot to warm the air space within the boot and having a top cap at the end to prevent loss of heat. This device is bulky and cumbersome to store, when not in use. Other boot warmers are: Lakie, U.S. Pat. No. 4,845,338 dated Jul. 4, 1989 providing an inflatable boot liner with electrical generator and a heater involving complex construction and a power source; Lakie, U.S. Pat. No. 4,823,482 dated Apr. 25, 1989 is another inner shoe with a heat engine for a boot or shoe to heat or cool a boot also involving a complex construction; Stem, U.S. Pat. No. 4,228,928 dated Sep. 15, 1981 is a method of heating boots via a heater affixed to the sole of a ski boot; Lee, U.S. Pat. No. 4,145,602 dated Mar. 20, 1979 discloses a ski boot and glove warmer having a pair of spaced apart horizontal dryer tubes and support rack.

Cited for general interest are: Shouse et al., U.S. Pat. No. 5,542,191 dated Aug. 6, 1996 discloses a footwear drying insert including a desiccant to absorb boot moisture; Khoury et al, U.S. Pat. No. 5,291,661 dated Mar. 8, 1994 discloses a shoe preserver having a wicking portion and an absorbing portion retained within a shoe form for storage; Ueki, U.S. Pat. No. 6,328,761 B1 dated Dec. 11, 2001 discloses a disposable body warmer for use in footwear containing an exothermic material to warm the feet when boots are worn in cold environs; Krell, U.S. Pat. No. 3,823,434 dated Jul. 16, 1974 discloses a ski boot heater comprises a container adapted to receive and hold hot liquids to heat ski boots before use; E.G. Smith, U.S. Pat. No. 1,270,666 dated Jun. 25, 1918 discloses a shoe drier constructed to conform to substantially the shape of a shoe with a moisture absorbing material cover and an opening in the top through which heating elements can be passed to dry boots; Lavine, U.S. Publication No. 2002/0193857A1 published Dec. 19, 2002 discloses a therapeutic temperature retaining pad with removable cover and Bastille, U.S. Pat. No. 5,571,155 dated Nov. 5, 1996 These boot heaters have various advantages and disadvantages.

The present invention is designed for usage with winter, cold weather, ski boots and other shoes, which may be heated before use for softening or comfort and sometimes to insure proper fit, hereinafter all referred to as boot/ski boot. It provides a boot heating system, which is reusable, can be heated via an oven or microwave, and is readily storable.

### SUMMARY OF THE INVENTION

The invention comprises a boot/ski boot softener and warmer. It has at least one flexible heatable insert with a top, sole, and perimeter sized to fit within a desired segment of the interior of a boot or shoe. This insert filled with a heatable or microwavable material, which, when heated, absorbs and then emits heat to warm and soften boots/ski boots. Covering the heatable insert is a heat-regulating sleeve made of a material, which releases sufficient heat to warm and soften the boot, but not sufficient heat to alter its shape. The heat-regulating sleeve may be firmly affixed to or removable from the heatable insert. Preferably, this heat-regulating sleeve material also minimizes friction so that the sleeved insert may more readily slide in and out of the boot interior. The preferred heatable or microwavable fill material comprises buckwheat hulls, grains or rice, or other synthetic materials such as the gel packs produced by Rapid Aid of Ontario, Canada, CryoPak of Vancouver, Canada, the salt sodium acetate heat packs made by numerous companies, such as Repeatheat, and Fusion Heat, or other artificial materials having similar heat releasing characteristics, all hereinafter referred to as heatable microwavable fill material. The heat-regulating sleeve is made of a material, which will not burn a user handing the same when heated, such as fleece, flannel, or neoprene.

When grains or rice are used as the fill material, an absorbent outer sleeve covering the heat-regulating sleeve may be included to absorb any moisture released from the heated grain or rice fill material to prevent it from accumulating on the interior of the boot. Usually moisture is emitted during the first heatings of these grains and gradually declines until there is no need for the absorbent outer sleeve. In wet conditions, a heat transferring water proof sleeve covering the heat-regulating sleeve may be included to prevent it from getting wet. If desired, the absorbent outer sleeve and waterproof sleeves may be placed between the heat-regulating sleeve and the heatable insert or surrounding the same.

Preferably, the heat-regulating sleeve is made of a washable material, and is removably secured around the heatable insert so that it may be periodically removed for washing. The heat-regulating sleeve may include heat-transmitting panels framed within segments of the heat-regulating sleeve to direct more or less heat at desired segments of the boot interior. For example, the heat-transmitting panels proximate the boot interior toe area are generally constructed of a material to direct more heat to warm and soften the toe area of the boot. Conversely, the heat-transmitting panels proximate the boot interior heel area are generally constructed of a material, such as leather, which retards heat transmission to prevent altering the shape and fit of the boot.

The heat-regulating sleeve preferably includes a friction reducing strip attached to the exterior of the heat-regulating sleeve along its sole and perimeter to aid in insertion and removal.

A preferred embodiment of the boot/ski boot softener and warmer comprises a pair of flexible heatable insert shaped and sized to fit within desired segments of the interiors of each pair of boots. The shape of the heatable inserts is sized similar to a foot with a toe, heel, and lower leg area so that they contact the interior of a ski boot to minimize voids when inserted. These inserts are filled with grains or similar types of materials, which, when heated, absorb and then emit heat to warm and soften boots/ski boots. Heat-regulating sleeves made of Fleece, or similar slow heat releasing materials, have an open top in a sock like shape so that the flexible heatable inserts can fit therein. Along the top of the heat-regulating sleeves are nylon or similar heat-transmitting materials formed in panels or strips proximate the boot interior top and toe area to direct more heat to warm and soften these portions of a boot. Heat retarding transmitting panels proximate the boot interior heel area may be included to reduce heat transmission to prevent altering the shape of a heat fitted ski boot. A friction reducing strip is placed along the outer perimeter of the bottom of the heat-regulating sleeve to reduce friction when the boot/ski boot softener slides in and out of a ski boot.

The heat-regulating sleeves are removably secured around the heatable inserts so that they may be periodically removed for washing. To aid in their removal and handling, pulling means, such as a toggle, pull loops or finger pull tabs are usually attached to the tops of the regulating sleeves proximate their openings.

The shape and dimensions of the inserts are preferably of a foot type shape to facilitate insertion into and filling the interior cavity space of a shoe, boot/ski boot. They are especially designed for the softening of otherwise stiff and rigid plastic shelled ski boots, and may also be used to dry boots or shoes. For shoes, shorter length insert shapes may be employed, such as ankle length or heel covering inserts for ankle length boots or shoes. These inserts not only fill the interior cavities of the boots or shoes, but may be inserted into articles of clothing to provide clothing warmers.

No boot caps are required to hold in heat. If optimal heat conservation is desired, the boots themselves may be put leg opening to leg opening to trap top insert released heat into the boots. This elimination of boot caps enables better storage and transport, when not in use.

The preferred embodiment is made of a fabric or other flexible material cover, such as flannel or neoprene, filled with gel packs, rice, buckwheat hulls, or similar granular materials, which can be heated or micro waved to absorb heat and/or otherwise generate heat through a chemical or other reaction. After heating, the heat-regulating sleeve covered heatable inserts are inserted into the boot to gradually release heat therein to warm and soften boots. Thereafter, they are removed and stored for reuse. To assist in insertion and removal, the finger pull or tab, is generally employed.

It is also envisioned that the heat-regulating sleeve may be an integral part of the heatable insert constructed of segments of a heat permeable material held together with a mesh or covering to secure therein the heatable grains or gel material. The heat permeable material is sized and constructed of a material having the required heat-transmitting properties to selectively direct more or less heat into specified areas of a boot interior.

The invention thus provides reusable heat-regulating sleeve covered heatable insert, which may be used for boot softening and warming or heating articles of clothing.

### BRIEF DESCRIPTION OF THE DRAWINGS

FIG. 1 is a side view of a preferred embodiment.

FIG. 2 is a side view of the heatable insert of the preferred embodiment shown in FIG. 1.

FIG. 3 is a front perspective view of a heat-regulating sleeve of the preferred embodiment shown in FIG. 1.

FIG. 4 is a rear perspective view of the heat-regulating sleeve 14 of the preferred embodiment shown in FIG. 1.

FIG. 5 is a side view of the preferred embodiment of FIG. 1 with an absorbent outer sleeve.

FIG. 6 is a side view of a waterproof sleeve.

FIG. 7 is a is a front perspective view of an ankle length preferred embodiment

### DESCRIPTION OF THE ILLUSTRATED EMBODIMENTS

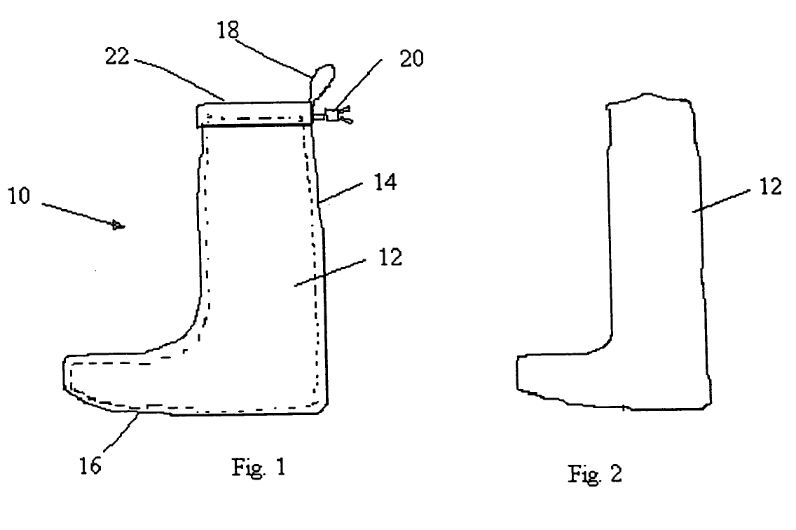

The invention comprises a boot/ski boot softener and warmer 10 shown in FIG. 1. It comprises a flexible boot shaped heatable insert 12 shown in FIG. 2 filled with a heatable or microwavable material, which, when heated, absorbs and then emits heat to warm and soften structured preferably of a foot type shape to facilitate insertion into and filling the interior cavity space of a shoe, boot or ski boot to be warmed. The heat-regulating sleeve 14 shown is made of a fleece or similar material, which releases sufficient heat to warm and soften the boot, but not sufficient heat to alter the shape of self molding ski boots. This fleece heat-regulating sleeve 14 will not burn a user handing the same when heated. Other similar materials resistant to absorbs ion of water for the heat-regulating sleeve 14 may also be employed.

The area of the sole 16 of the heat-regulating sleeve 14 and heatable insert 12 proximate the toe and ball of the foot are upward curving to aid in boot insertion.

The boot/ski boot softener and warmers 10 are especially designed for the softening of otherwise stiff and rigid plastic shelled ski boots, and may also be used to dry boots or shoes. After heating, the boot shaped heatable inserts 12 covered with a heat-regulating sleeve 14 are inserted into the boot to gradually release heat therein to warm and soften ski boots. Thereafter, they are removed and stored for reuse. To assist in insertion and removal, a finger pull 18, may be included. To removably secure the heatable inserts 12 within the heat-regulating sleeve 14, a draw string tie 20 is associated with the top of the sleeve opening 22.

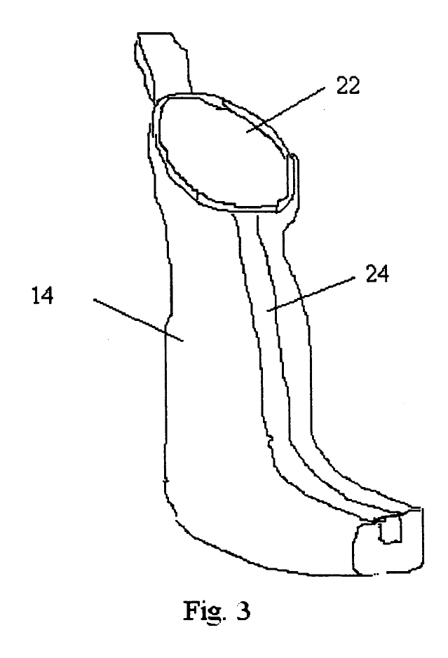

FIG. 3 is a front perspective view of a heat-regulating sleeve 14 of the preferred embodiment shown in FIG. 1. The embodiment shown incorporates a nylon rapid heat-releasing strip 24 sewn along the top front of the heat-regulating sleeve 14 to transmit more heat from the heatable insert 12 into the top and toe of the boot interior than passes through the sleeve 14. This provides more heat to soften and warm these interior areas of the boot.

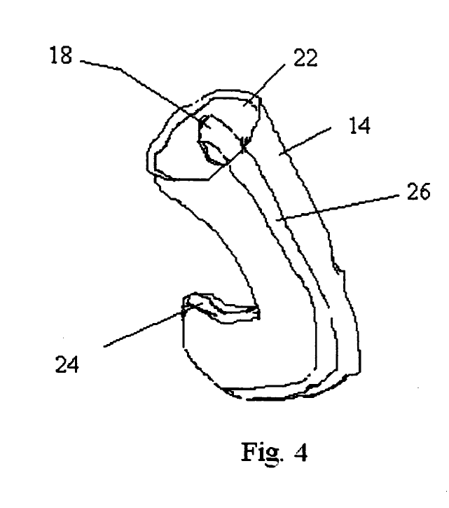

FIG. 4 is a rear perspective view of the heat-regulating sleeve 14 of the preferred embodiment shown in FIG. 1. A nylon friction-reducing strip 26 forming the finger pull 18 is sewn along the back and sole of the heat-regulating sleeve 14 to reduce friction contact with the boot to aid in its insertion therein for warming. The thickness of this added friction-reducing strip 26 also provides added insulation proximate the bottom of the heel of the boot to prevent overheating and altering the boot shape.

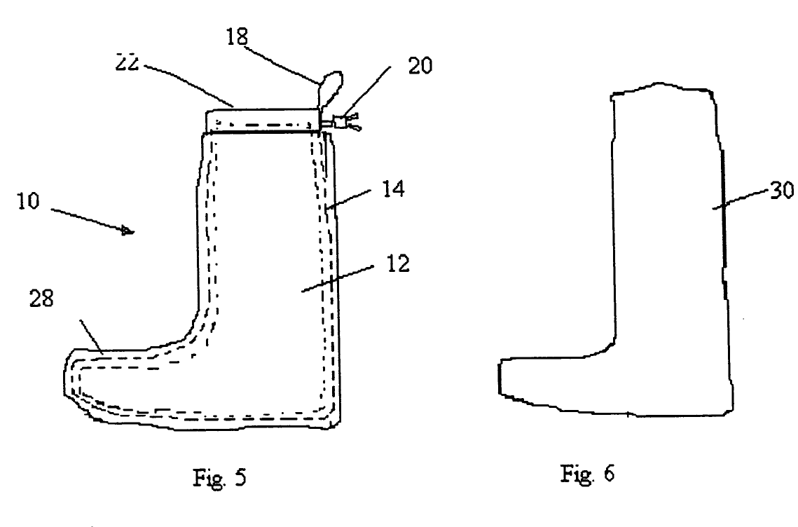

FIG. 5 is a side view of the preferred embodiment of FIG. 1 with an absorbent sleeve 28 made of cotton or similar material to absorb water generated during microwave heating of the grain filling.

FIG. 6 is a side view of a waterproof sleeve 30, sized to cover the heat-regulating sleeve 14 to shield it from external moisture. This waterproof sleeve 30 is made of flexible plastic, leather, or other water resistant material, which readily transmit heat there through.

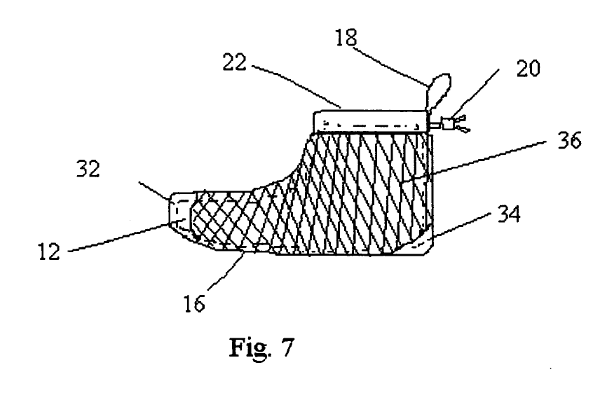

FIG. 7 is a front perspective view of an ankle length preferred embodiment smaller in length to that shown in FIG. 1 for a calf length boot. A heat transmitting panel 32 covers the toe segment of the heat-regulating sleeve 14 to transmit more heat in the interior toe region of the boot. A heat-retarding panel 34 covers the heel segment of the heat-regulating sleeve 14 to prevent overheating of the heel region of the boot. Both panels 32, 34 are held together with mesh netting 36 to secure therein a heatable gel insert 12.

Although this specification has referred to the illustrated embodiments, it is not intended to restrict the scope of the appended claims. The claims themselves recite those features deemed essential to the invention.

1. A boot/ski boot softener and warmer comprising:
a. at least one flexible heatable insert with a top, sole, and perimeter shaped and sized to fit within a desired segment of the interior of a boot, said insert filled with a heatable or microwavable material, which, when heated, absorbs and then emits heat to warm and soften boots/ski boots,
b. a heat-regulating sleeve covering the heatable insert made of a material which releases sufficient heat to warm and soften the boot, but not sufficient heat to alter its shape which also generates minimal friction so that the covered sleeved insert may slide in and out of the boot interior.

2. A boot/ski boot softener and warmer according to claim 1, wherein the heatable or microwavable fill material comprises gel packs, buckwheat hulls, grains, and/or rice.

3. A boot/ski boot softener and warmer according to claim 1, wherein the heat-regulating sleeve is made of a material, which will not burn a user handing the same when heated.

4. A boot/ski boot softener and warmer according to claim 1, including an absorbent sleeve covering the heatable insert and/or heat-regulating sleeve to absorb moisture from grain or rice fill material to prevent it from accumulating on the interior of the boot.

5. A boot/ski boot softener and warmer according to claim 4, including a heat transferring water proof sleeve covering the heatable insert and/or heat-regulating sleeve to prevent them from getting wet.

6. A boot/ski boot softener and warmer according to claim 1, wherein the heat-regulating sleeve is made of a washable material, and is removably secured around the heatable insert so that it may be periodically removed for washing.

7. A boot/ski boot softener and warmer according to claim 1, including heat-transmitting panels framed within segments of the heat-regulating sleeve to direct more or less heat at desired segments of the boot interior.

8. A boot/ski boot softener and warmer according to claim 1, wherein the heat-regulating sleeve is an integral part of the heatable insert and is constructed with segments of a heat permeable material held together with mesh or cloth panels structured to hold the heatable or microwavable material and selectively release heat into desired segments of a boot interior.

9. A boot/ski boot softener and warmer according to claim 7, wherein the heat-transmitting panels proximate the boot interior toe area direct more heat to warm and soften the boot, and the heat-transmitting panels proximate the boot interior heel area to retard heat transmission to prevent altering the shape and fit of the boot.

10. A boot/ski boot softener and warmer according to claim 7, including a friction reducing strip or patch attached to the exterior of the heat-regulating sleeve along its sole to aid in insertion and removal.

11. A boot/ski boot softener and warmer according to claim 10, wherein the friction reducing strip or patch also moderates heat flow.

12. A boot/ski boot softener and warmer comprising:
a. at least one flexible heatable insert with a top, heel, toe, and sole sized to fit within a desired segment of the interior of a boot, said insert filled with gel packs and/or grains, which, when heated, absorb and then emit heat to warm and soften boots/ski boots,
b. a heat-regulating sleeve made of a durable material covering the heatable insert and including heat-transmitting panels, which when inserted are located proximate the boot interior top and toe area to direct more heat to warm and soften these segments of the boot, and the heat retarding transmitting panels proximate the boot interior heel area to reduce heat transmission to prevent altering the shape and fit of the boot, and
c. a friction reducing strip along the outer perimeter sole of the heat-regulating sleeve to reduce friction when the sleeve slides in and out of the boot interior.

13. A boot/ski boot softener and warmer according to claim 12, including an absorbent sleeve covering the heatable insert and/or the heat-regulating sleeve to absorb moisture from grain or rice fill material to prevent it from accumulating on the interior of the boot.

14. A boot/ski boot softener and warmer according to claim 12, including a heat transferring water proof sleeve covering the heatable insert and/or the heat-regulating sleeve to prevent it from getting wet.

15. A boot/ski boot softener and warmer according to claim 12, wherein the heat-regulating sleeve is removably secured around the heatable insert so that it may be periodically removed for washing.

16. A boot/ski boot softener and warmer according to claim 12, including hand pulling means attached to the top of the boot/ski boot softener and warmer to aid in its removal and handling.

17. A boot/ski boot softener and warmer according to claim 12, wherein the sole of the insert proximate the toe segment is curved upward toward its top to aid in insertion and removal from the boot.
